(19) United States
(12) Patent Application Publication
(10) Pub. No.: US 2017/0048906 A1
(43) Pub. Date: Feb. 16, 2017

(54) OPERATION METHOD OF COMMUNICATION NODE SUPPORTING DEVICE TO DEVICE COMMUNICATION IN COMMUNICATION NETWORK

(71) Applicant: ELECTRONICS AND TELECOMMUNICATIONS RESEARCH INSTITUTE, Daejeon (KR)

(72) Inventors: Kyoung Seok LEE, Daejeon (KR); Jae Heung KIM, Daejeon (KR); Jae Sheung SHIN, Daejeon (KR)

(73) Assignee: ELECTRONICS AND TELECOMMUNICATIONS RESEARCH INSTITUTE, Daejeon (KR)

(21) Appl. No.: 15/236,088

(22) Filed: Aug. 12, 2016

(30) Foreign Application Priority Data
Aug. 13, 2015 (KR) 10-2015-0114621
May 13, 2016 (KR) 10-2016-0058693
Aug. 5, 2016 (KR) 10-2016-0099949

(51) Int. Cl. H04W 76/02

(52) U.S. Cl. CPC H04W 76/023; H04W 88/04

(57) ABSTRACT

Disclosed are operation methods of communication node supporting device to device communications in communication system. The operation method of the communication node comprises receiving relay operation criterion information from a base station; when it is determined that the first communication node supports a relay function based on the relay operation criterion information, transmitting a first message indicating that the first communication node supports the relay function to the base station; and when a second message which instructs performing of the relay function is received from the base station in response to the first message, relaying communications between the base station and a second communication node by performing the relay function.

### CROSS-REFERENCE TO RELATED APPLICATIONS

This application claims the benefit of and priorities to Korean Patent Application No. 10-2015-0114621 filed on Aug. 13, 2015, Korean Patent Application No. 10-2016-0058693 filed on May 13, 2016, and Korean Patent Application No. 10-2016-0099949 filed on Aug. 5, 2016 in the Korean Intellectual Property Office (KIPO), the entire contents of which are hereby incorporated by reference.

### BACKGROUND

1. Technical Field

The present disclosure relates to communication technologies of a communication node supporting device to device (D2D) communications in a communication system, and more particularly, to operation methods of the communication node which relays communications between a base station and other user equipment (UE).

2. Related Art

In a cellular communication system, a user equipment (UE) may generally transmit or receive data through a base station. For example, in the case that data which will be transmitted to a second UE exists, a first UE may generate a message including the data which will be transmitted to the second UE and transmit the generated message to a first base station to which the first UE belongs. The first base station may receive the message from the first UE and identify that a destination of the received message is the second UE. The first base station may transmit the message to a second base station to which the second UE, as the identified destination, belongs. The second base station may receive the message from the first base station and identify that the destination of the received message is the second UE. The second base station may transmit the message to the second UE as the identified destination. The second UE may receive the message from the second base station and obtain the data included in the received message.

Meanwhile, device to device (D2D) communications may indicate that a UE directly communicates with other UE. For example, in the case that the D2D communications between the first UE and the second UE are performed, the first UE may generate a message including data to be transmitted to the second UE and directly transmit the generated message to the second UE. The second UE may receive the message including the data from the first UE and obtain the data included in the message.

Here, the UE performing the D2D communications (hereinafter, “D2D UE”) may relay communications between the base station and other UE. For example, the D2D UE supporting relay function may relay data communications between the base station and the UE which is located out of a cell radius of the base station or between the base station and the UE, which is located in the cell radius of the base station, having an unstable communication state with the base station. Therefore, communication coverage of the base station may be increased by the D2D UE supporting the relay function. However, operations of the D2D UE supporting the relay function are not defined specifically.

Meanwhile, this description on the related arts is written for understanding of the background of the present disclosure. Thus, information on other than conventional technologies, which are already known to those skilled in this technology domain to which the technologies of the present disclosure belong, may be included in this description.

### SUMMARY

Accordingly, embodiments of the present disclosure are provided to substantially obviate one or more problems due to limitations and disadvantages of the related art. The embodiments of the present disclosure provide operation methods of a communication node relaying communications between a base station and other terminal in a communication system.

In accordance with the embodiments of the present disclosure, an operation method of a first communication node supporting device to device (D2D) communications in a communication system may be provided. The operation method comprises receiving relay operation criterion information from a base station; when it is determined that the first communication node supports a relay function based on the relay operation criterion information, transmitting a first message indicating that the first communication node supports the relay function to the base station; and when a second message which instructs performing of the relay function is received from the base station in response to the first message, relaying communications between the base station and a second communication node by performing the relay function.

Here, when the first communication node is in a radio resource control (RRC) connected state, the relay operation criterion information may be received through a RRC message.

Here, when the first communication node is in a RRC idle state, the relay operation criterion information may be received through a reception procedure of system information or a paging procedure.

Here, the relay operation criterion information (e.g. relay operation configuration information, relay capability information) may include at least one of a threshold for a noise level of a channel, a threshold for a data transmission rate, and a threshold for a battery remaining capacity.

Here, the operation method may further comprise transmitting state information of the first communication node to the base station, wherein the state information may be used for determining an arbitrary communication node to perform the relay function and include a noise level of a channel in which the first communication node operates, a data transmission rate supported by the first communication node, and a battery remaining capacity of the first communication node.

Here, the operation method may further comprise performing state transition of the first communication node from a RRC connected state to a RRC idle when the second message is not received in predefined time duration.

Here, the relaying the communications between the base station and the second communication node may comprise transmitting a discovery channel; receiving a response signal in response to the discovery channel from the second communication node; and configuring a D2D link between the first communication node and the second communication node.

Here, information of radio resources in which the discovery channel is transmitted may be obtained from the base station or configured by the first communication node.

Here, the information of the radio resources may include information of time and frequency resources of the discovery channel, information of transmit power, period information, and synchronization information.

Here, the first communication node may be located in cell coverage of the base station, and the second communication node may be located out of the cell coverage of the base station.

Furthermore, in accordance with the embodiments of the present disclosure, a first communication node supporting device to device (D2D) communications in a communication system may be provided. The first communication node comprises a processor; and a memory storing at least one command which is executed by the processor, wherein the at least one command is executed to receive relay operation criterion information from a base station; when it is determined that the first communication node supports a relay function based on the relay operation criterion information, transmit a first message indicating that the first communication node supports the relay function to the base station; and when a second message which instructs performing of the relay function is received from the base station in response to the first message, relay communications between the base station and a second communication node by performing the relay function.

Here, when the first communication node is in a radio resource control (RRC) connected state, the relay operation criterion information may be received through a RRC message.

Here, when the first communication node is in a RRC idle state, the relay operation criterion information may be received through a reception procedure of system information or a paging procedure.

Here, the relay operation criterion information may include at least one of a threshold for a noise level of a channel, a threshold for a data transmission rate, and a threshold for a battery remaining capacity.

Here, the at least one command may be executed further to transmit state information of the first communication node to the base station, wherein the state information may be used for determining an arbitrary communication node to perform the relay function and include a noise level of a channel in which the first communication node operates, a data transmission rate supported by the first communication node, and a battery remaining capacity of the first communication node.

Here, the at least one command may be executed further to perform state transition of the first communication node from a RRC connected state to a RRC idle when the second message is not received in predefined time duration.

Here, when the communications between the base station and the second communication node are relayed, the at least one command may be executed to transmit a discovery channel; receive a response signal in response to the discovery channel from the second communication node; and configure a D2D link between the first communication node and the second communication node.

Here, information of radio resources in which the discovery channel is transmitted may be obtained from the base station or configured by the first communication node.

Here, the information of the radio resources may include information of time and frequency resources of the discovery channel, information of transmit power, period information, and synchronization information.

Here, the first communication node may be located in cell coverage of the base station, and the second communication node may be located out of the cell coverage of the base station.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram showing embodiments of a communication system;

FIG. 2 is a block diagram showing embodiments of a communication node in a communication system;

FIG. 3 is a sequence chart showing operation methods of a communication node supporting D2D communications in a communication system according to an embodiment of the present disclosure:

FIG. 4 is a sequence chart showing operation methods of a communication node supporting D2D communications in a communication system according to other embodiment of the present disclosure;

FIG. 5 is a sequence chart showing transmission methods of PRACH in a communication system according to embodiments of the present disclosure;

FIG. 6 is a conceptual diagram showing allocation methods of radio resources for PRACH in a communication system according to embodiments of the present disclosure; and

FIG. 7 is a conceptual diagram showing a random access procedure in a communication system according to embodiments of the present disclosure.

### DETAILED DESCRIPTION OF THE EMBODIMENTS

The present disclosure may be modified in various ways and the present disclosure may include various embodiments. The embodiments will be shown in figures and described in detail. However, the present disclosure is not limited to specific embodiments. It should be understood that the present disclosure includes all modifications, similar embodiments, and alternative embodiments belonging to idea and technical scope thereof.

The terms “first, second, and so on” will be used for describing various elements. However, the elements are not limited thereto. These terms are only used to distinguish one element from another. For example, a first element could be termed a second element, and, similarly, the second element could be termed the first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, in the case that an element is referred to as being “directly connected” or “directly coupled” to another element, it will be understood that there are no intervening elements.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which embodiments according to the present disclosure are applied will be described as below. The communication system to which the embodiments according to the present disclosure are applied is not limited to description below, and the embodiments according to the present disclosure may be applied to various communication system. Here, the communication system may indicate a wireless communication network or a wireless communication system.

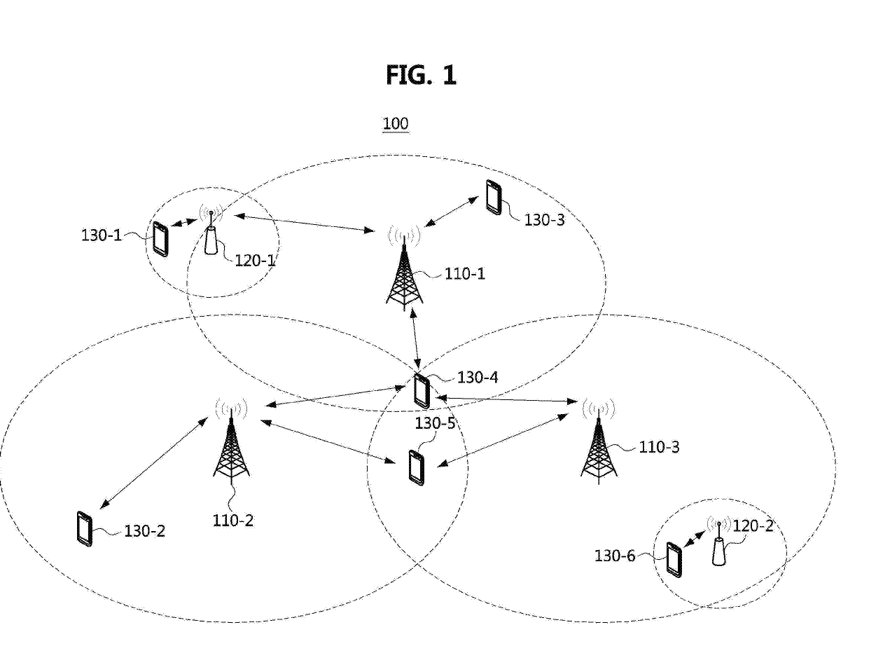

Referring to FIG. 1, a communication system 100 may include a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier-frequency division multiple access (SC-FDMA) based communication protocol, and so on. Each of the plurality of communication nodes may have following structure.

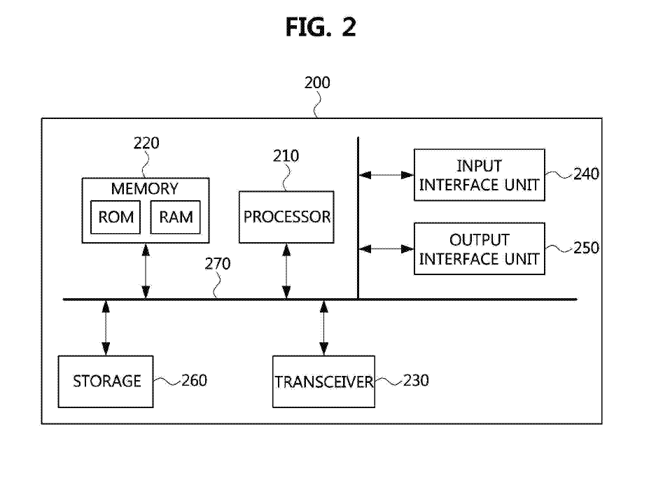

FIG. 2 is a block diagram showing embodiments of a communication node in a communication system.

Referring to FIG. 2, a communication node 200 may include at least one processor 210, a memory 220, and a transceiver 230 connected to a network and performing communication. In addition, the communication node 200 may further include an input interface unit 240, an output interface unit 250, a storage 260, and so on. The respective components included in the communication node 200 may be connected via a bus 270 to communicate with each other.

The processor 210 may execute a program command stored in the memory 220 and/or the storage 260. The processor 210 may be a central processing unit (CPU), a graphics processing unit (GPU) or a dedicated processor in which the methods according to embodiments of the present disclosure are performed. Each of the memory 220 and the storage 260 may include a volatile storage medium and/or a nonvolatile storage medium. For example, the memory 220 may include a read only memory (ROM) and/or a random access memory (RAM).

Re-referring to FIG. 1, the communication system 100 may include a plurality of base stations 110-1, 110-2, 110-3, 120-1, and 120-2 and a plurality of user equipment (UEs) 130-1, 130-2, 130-3, 130-4, 130-5, and 130-6. Each of a first base station 110-1, a second base station 110-2, and a third base station 110-3 may form a macro cell. Each of a fourth base station 120-1 and a fifth base station 120-2 may form a small cell. The fourth base station 120-1, a third UE 130-3, and a fourth UE 130-4 may belong to cell coverage of the first base station 110-1. A second UE 130-2, the fourth UE 130-4, and a fifth UE 130-5 may belong to cell coverage of the second base station 110-2. The fifth base station 120-2, the fourth UE 130-4, the fifth UE 130-5, and a sixth UE 130-6 may belong to cell coverage of the third base station 110-3. The first UE 130-1 may belong to cell coverage of the fourth base station 120-1. The sixth UE 130-6 may belong to cell coverage of the fifth base station 120-2.

Here, each of the plurality of base stations 110-1, 110-2, 110-3, 120-1, and 120-2 may be referred to as a NodeB, an evolved NodeB, a base transceiver station (BTS), a radio base station, a radio transceiver, an access point, an access node, and so on. Each of the plurality of UEs 130-1, 130-2, 130-3, 130-4, 130-5, and 130-6 may be referred to as a terminal, an access terminal, a mobile terminal, a station, a subscriber station, a mobile station, a portable subscriber station, a node, a device, and so on. Alternatively, each of the plurality of UEs 130-1, 130-2, 130-3, 130-4, 130-5, and 130-6 may be a vehicle or a communication node include in the vehicle.

Each of the plurality of communication nodes 110-1, 110-2, 110-3, 120-1, 120-2, 130-1, 130-2, 130-3, 130-4, 130-5, and 130-6 may support long term evolution (LTE) (or, long term evolution-advanced (LTE-A)) defined in a cellular communication standard (e.g., 3rd generation partnership project (3GPP) standard). Each of the plurality of base stations 110-1, 110-2, 110-3, 120-1, and 120-2 may operate in different frequency band or same frequency band. Each of the plurality of base stations 110-1, 110-2, 110-3, 120-1, and 120-2 may be connected to each other through an ideal backhaul or a non-ideal backhaul and exchange information each other through the ideal backhaul or the non-ideal backhaul. Each of the plurality of base stations 110-1, 110-2, 110-3, 120-1, and 120-2 may be connected to a core network (non-shown) through the ideal backhaul or the non-ideal backhaul. Each of the plurality of base stations 110-1, 110-2, 110-3, 120-1, and 120-2 may transmit a signal, which is received from the core network, to corresponding UE 130-1, 130-2, 130-3, 130-4, 130-5, and 130-6 and transmit a signal, which is received from the corresponding UE 130-1, 130-2, 130-3, 130-4, 130-5, and 130-6, to the core network.

Each of the plurality of base stations 110-1, 110-2, 110-3, 120-1, and 120-2 may support downlink transmission based on OFDMA and uplink transmission based on SC-FDMA. In addition, each of the plurality of base stations 110-1, 110-2, 110-3, 120-1, and 120-2 may support multiple input multiple output (MIMO) transmission (e.g., single user-multiple input multiple output (SU-MIMO), multi user-multiple input multiple output (MU-MIMO), massive MIMO, etc.), coordinated multipoint (CoMP) transmission, carrier aggregation (CA) transmission, transmission in an unlicensed band, device to device (D2D) communications (or, proximity service (ProSe)), and so on. Here, each of the plurality of UEs 130-1, 130-2, 130-3, 130-4, 130-5, and 130-6 may perform operations corresponding to or supported by the base station 110-1, 110-2, 110-3, 120-1, and 120-2.

For example, the second base station 110-2 may transmit a signal to the fourth UE 130-4 based on a SU-MIMO manner, and the fourth UE 130-4 may receive the signal from the second base station 110-2 based on the SU-MIMO manner. Alternatively, the second base station 110-2 may transmit a signal to the fourth UE 130-4 and the fifth UE 130-5 based on a MU-MIMO manner, and each of the fourth UE 130-4 and the fifth UE 130-5 may receive the signal from the second base station 110-2 based on the MU-MIMO manner. Each of the first base station 110-1, the second base station 110-2, and the third base station 110-3 may transmit a signal to the fourth UE 130-4 based on a CoMP manner, and the fourth UE 130-4 may receive the signal from the first base station 110-1, the second base station 110-2, and the third base station 110-3 based on the CoMP manner. Each of the plurality of the base stations 110-1, 110-2, 110-3, 120-1, and 120-2 may transmit or receive a signal to or from the UE 130-1, 130-2, 130-3, 130-4, 130-5, and 130-6 belonging to the cell coverage of it based on a CA manner. Each of the first base station 110-1, the second base station 110-2, and the third base station 110-3 may coordinate the D2D communications between the fourth UE 130-4 and the fifth UE 130-5, and each of the fourth UE 130-4 and the fifth UE 130-5 may perform the D2D communications by coordination of each of the second base station 110-2 and the third base station 110-3.

Next, an operation method of the communication node supporting device to device (D2D) communications in the communication system according to embodiments of the present disclosure will be described. Although a method (e.g., signal transmission or reception) performed by a first communication node will be described, a second communication node corresponding thereto may perform a method (e.g., signal reception or transmission) corresponding to the method performed by the first communication node. That is, when an operation of the UE is described, the base station corresponding thereto may perform an operation corresponding to the operation of the UE. On the contrary, when an operation of the base station is described, the UE may perform an operation corresponding to an operation of the base station.

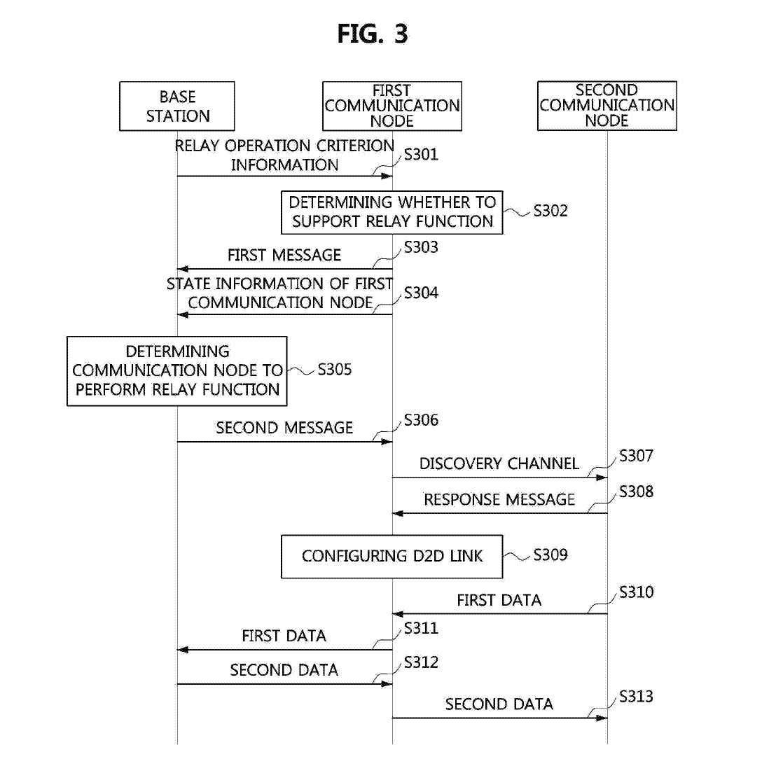

FIG. 3 is a sequence chart showing operation methods of a communication node supporting D2D communications in a communication system according to an embodiment of the present disclosure.

Referring to FIG. 3, a base station and a first communication node may form the communication system which has been described referring to FIG. 1. For example, the first communication node may be located in cell coverage (or communication coverage) of the base station. Each of the base station and the first communication node may be identical or similar to the communication node 200 which has been described referring to FIG. 2. The first communication node may receive relay operation criterion information from the base station (S301). In particular, in the case that the first communication node is in a radio resource control connected (RRC_CONNECTED) state, the relay operation criterion information may be received from the base station through a RRC message. Alternatively, in the case that the first communication node is in a RRC idle (RRC_IDLE) state, the relay operation criterion information may be received from the base station through a reception procedure of system information or a paging procedure.

Here, the relay operation criterion information received from the base station may include at least one of a threshold for a channel noise level, a threshold for received signal strength, a threshold for a data transmission rate, and a threshold for a battery remaining capacity. That is, the relay operation criterion may indicate a minimum criterion of the communication node for performing relay function in the communication system.

Then, the first communication node may determine whether to support the relay function based on the relay operation criterion information (S302). That is, the first communication node may determine whether a state of the first communication node corresponds with the relay operation criterion information. In particular, the first communication node may identify the channel noise level, the received signal strength, the data transmission rate, and the battery remaining capacity of the first communication node. Then, the first communication node may identify whether each of the identified channel noise level, the identified received signal strength, the identified data transmission rate, and the identified battery remaining capacity satisfies with each threshold included in the relay operation criterion information.

For example, in the case that the channel noise level of the first communication node is less than the threshold for the channel noise level included in the relay operation criterion information, the first communication node may determine that the channel noise level of the first communication node satisfies with the relay operation criterion information. In addition, in the case that the received signal strength of the first communication node is more than the threshold for the received signal strength included in the relay operation criterion information, the first communication node may determine that the received signal strength of the first communication node satisfies with the relay operation criterion information. In addition, in the case that the data transmission rate of the first communication node is more than the threshold for the data transmission rate included in the relay operation criterion information, the first communication node may determine that the data transmission rate of the first communication node satisfies with the relay operation criterion information. In addition, in the case that the battery remaining capacity of the first communication node is more than the threshold for the battery remaining capacity included in the relay operation criterion information, the first communication node may determine that the battery remaining capacity of the first communication node satisfies with the relay operation criterion information.

Then, when it is determined that the first communication node supports the relay function based on the relay operation criterion information (e.g., when at least one relay operation criterion among the relay operation criterions is satisfied), the first communication node may transmit a first message indicating that the first communication node supports the relay function to the base station (S303). Here, in the case that the first communication node is in the RRC_IDLE state, the state of the first communication node may be transitioned from the RRC_IDLE state to the RRC_CONNECTED state.

In this case, the first communication node may further transmit state information of the first communication node to the base station (S304), and the state information are used for determining an arbitrary communication node to perform the relay function. Alternatively, the first communication node may transmit the first message including the state information of the first communication node. Here, the state information of the first communication node may include the noise level of the channel in which the first communication node operates, the received signal strength, the data transmission rate supported by the first communication node, and the battery remaining capacity of the first communication node. In addition, the state information of the first communication node may further include movement information related to a movement speed or the number of cell movements of the first communication node.

Meanwhile, the base station may receive the first message indicating that the first communication node supports the relay function from the first communication node. In addition, the base station may further receive the state information of the first communication node from the first communication node. Then, the base station may identify that the first communication node supports the relay function based on the first message received from the first communication node. In this case, the base station may further receive a message indicating that the relay function is supported and state information from at least one communication node other than the first communication node.

Therefore, the base station may determine a communication node to perform the relay function among a plurality of communication nodes supporting the relay function (S305). In particular, the base station may determine the communication node to perform the relay function based on the state information of each communication node which are received from the plurality of communication nodes. In addition, the base station may determine the communication node to perform the relay function in consideration of the state information of the plurality of communication nodes as well as state information of the base station (e.g., the number of communication nodes which perform relay function in the cell coverage of the base station).

For example, the base station may determine the communication node having the lowest channel noise level among the plurality of communication nodes as the communication node to perform the relay function. In addition, the base station may determine the communication node having the strongest received signal strength among the plurality of communication nodes as the communication node to perform the relay function. In addition, the base station may determine the communication node having the highest data transmission rate among the plurality of communication nodes as the communication node to perform the relay function. In addition, the base station may determine the communication node having the highest battery remaining capacity among the plurality of communication nodes as the communication node to perform the relay function.

Then, in the case that the first communication node among the plurality of communication nodes is determined to as the communication node to perform the relay function, the base station may generate a second message which instructs performing the relay function in response to the first message. Then, the base station may transmit the second message which instructs performing the relay function to the first communication node (S306). Here, the second message may transmitted to the first communication node through a RRC signaling or physical downlink control channel (PDCCH) (or enhanced PDCCH (EPDCCH), physical downlink shared channel (PDSCH), and so on).

In contrast, in the case that other communication node other than the first communication node is determined to as the communication node to perform the relay function, the base station may transmit the second message to the determined communication node. Therefore, the first communication node may not receive the second message from the base station. In the case that the second message is not received from the base station in predefined time duration, the state of the first communication node may be transitioned from the RRC_CONNECTED state to the RRC_IDLE state.

Re-referring to FIG. 3, in the case that the second message which instructs performing of the relay function is received from the base station, the first communication node may relay communications between the base station and a second communication node (e.g., a communication node discovered by a discovery operation which will be described) by performing the relay function.

Here, the first communication node may be a communication node located in the cell coverage of the base station, and the second communication node may be a communication node located out of the cell coverage of the base station. That is, the first communication node may be located in the cell coverage of the base station and have a good communication state with the base station. In addition, the second communication node may be located out of the cell coverage of the base station and may be a communication node which does not communicate with the base station. Alternatively, the second communication node may be a communication node having an unstable communication state with the base station among communication nodes located in the cell coverage of the base station.

In particular, the first communication node may perform the discovery operation for discovering a counterpart communication node. For example, the first communication node may transmit the discovery channel (S307). Here, radio resources through which the discovery channel is transmitted are determined based on two types. According to a type1, the radio resources through which the discovery channel is transmitted are allocated from the base station. Alternatively, according to a type2, the radio resources through which the discovery channel is transmitted are configured by the first communication node.

For example, in the case that the radio resources through which the discovery channel is transmitted are allocated from the base station according to the type1, the first communication node may generate a message requesting allocation of the radio resources. In this case, the generated message may further include an indicator indicating that the discovery channel is used for discovering the counterpart communication node as a relay target. Then, the first communication node may transmit the message requesting allocation of the radio resources to the base station.

Meanwhile, the base station may receive the message requesting the allocation of the radio resources for transmission of the discovery channel from the first communication node. In addition, the base station may identify that the discovery channel is used for discovering the counterpart communication node as the relay target by identifying the indicator included in the message. Then, the base station may request the allocation of the radio resources for the transmission of the discovery channel to a higher layer and obtain information of the radio resources through which the discovery channel is transmitted from the higher layer. Then, the base station may generate a message including the obtained information of the radio resources and transmit the generated message to the first communication node.

Here, the information of the radio resources may include information of time and frequency resources, information of transmit power, period information, and synchronization information for the discovery channel. Here, the synchronization information may indicate synchronization information of the base station to which the first communication node has accessed.

Meanwhile, the first communication node may generate a message including the information of the radio resources allocated by the base station (or radio resources configured by the first communication node) and transmit the generated message. Here, the message may be transmitted in a broadcast manner. In addition, the synchronization information of the base station to which the first communication node has accessed may be transmitted through the message including the information of the radio resources or may be transmitted by a third communication node. The third communication node may synchronize with the base station to which the first communication node has accessed.

Meanwhile, the second communication node may obtain the synchronization information of the base station and synchronize with the base station based on the synchronization information. For example, in the case that the second communication node may be located out of the cell coverage of the base station, the second communication node may obtain the synchronization information of the base station from the first communication node or the third communication node. Alternatively, in the case that the second communication node may be located in the cell coverage of the base station, the second communication node may obtain the synchronization information of the base station from the base station (or first communication node, third communication node). The second communication node may receive the message including the information of the radio resources for the transmission of the discovery channel from the first communication node and identify the radio resources through which the discovery channel will be transmitted, the transmit power of the discovery channel, and so on based on the message.

The first communication node may transmit the discovery channel through the radio resources allocated by the base station (or radio resources configured by the first communication node) (S307). The discovery channel may include information of a channel state between the base station and the first communication node.

The second communication node may receive the discovery channel from the first communication node and perform decoding (e.g., cyclic redundancy check (CRC)) on the discovery channel. In the case that the decoding on the discovery channel is successfully performed, the second communication node may transmit a response message in response to the discovery channel to the first communication node (S308).

In addition, the second communication node may obtain the indicator indicating that the first communication node supports the relay function from the discovery channel and identify that the first communication node supports the relay function (e.g., the first communication node relays communications between the base station and the second communication node) based on the indicator. In addition, the second communication node may obtain the state information between the base station and the first communication node from the discovery channel and identify the channel state between the base station and the first communication node based on the state information.

In addition, in the case that a plurality of discovery channels are received, the second communication node may select one communication node based on the channel state and transmit the response message in response to the discovery channel to the selected communication node. For example, the second communication node may identify the channel state between the base station and each communication node, based on the channel state between the base station and each communication node included in the channel state information included in the plurality of discovery channels. Then, the second communication node may select a communication node having the channel state with the base station which is more than a predefined criterion and transmit the response message in response to the discovery channel to the selected communication node. Here, the predefined criterion may indicate a case in that the channel noise level between the base station and the communication node is less than a predefined threshold or a case in that the data transmission rate between the base station and the communication node is more than a predefined threshold.

Alternatively, in the case that the second communication node is located in the cell coverage of the base station, the second communication node may measure a radio channel state (e.g., radio link quality) of a PC5 interface between the first communication node and the second communication node by receiving the discovery channel (e.g., by identifying strength of the received discovery channel). The second communication node may transmit information indicating the measured radio channel state to the base station.

The base station may receive the information indicating the radio channel state from the second communication node and transmit an indicator which indicates that the D2D communications with the first communication node are allowed to the second communication node when the radio channel state satisfies with the predefined criterion. In the case that the indicator which indicates that the D2D communications with the first communication node are allowed is received, the second communication node may transmit the response message in response to the discovery channel to the first communication node.

Therefore, the first communication node may receive the response message in response to the discovery channel from the second communication node. Here, the response message received from the second communication node may indicate a message requesting configuration of a D2D link between the first communication node and the second communication node. Then, the first communication node may determine whether to perform the configuration of the D2D link between the first communication node and the second communication node based on the predefined criterion.

For example, in the case that the number of communication nodes which have accessed to the first communication node is equal to or more than a predefined number, the first communication node may limit the configuration of the D2D link between the first communication node and the second communication node. In addition, in the case that the data transmission rate used for the relay function is equal to or less than a predefined value, the first communication node may limit the configuration of the D2D link between the first communication node and the second communication node.

In contrast, when it is determined that the configuration of the D2D link between the first communication node and the second communication node is possible based on the predefined criterion, the first communication node may configure the D2D link with the second communication node (S309). Here, for stability and security of the D2D communications, the D2D link between the first communication node and the second communication node may be used as a link separated from a general D2D link. In addition, the D2D link between the first communication node and the second communication node may use radio resources separated from the general D2D link.

In addition, the D2D link between the first communication node and the second communication node may configure a relay bearer for the relay function as a signal radio bearer (SRB). The relay bearer for the relay function and the SRB may be independently operated each other. For the relay function of at least one communication node other than the second communication node, the first communication node may use the D2D link for the relay function. Here, a communication manner which is performed between the first communication node and the second communication node may be a unicast transmission manner in view of the higher layer or a D2D communication manner in view of a lower layer.

As the foregoing description, the first communication node may relay communications between the base station and the second communication node by performing the relay function through the configured D2D link. In particular, in the case that first data which will be transmitted to the base station is generated, the second communication node may generate a message including the first data. Then, the second communication node may transmit the message including the first data to the first communication node (S310).

Meanwhile, the first communication node may receive the message including the first data from the second communication node through the D2D link. Then, the first communication node may transmit the message including the first data to the base station (S311).

Therefore, the base station may receive the message including the first data from the first communication node. Then, in response to the first data, the base station may generate a message including second data. Then, the base station may transmit the message including the second data to the first communication node (S312). Therefore, the first communication node may receive the message including the second data from the base station. Then, the first communication node may transmit the message including the second data to the second communication node through the D2D link (S313).

Meanwhile, in the case that the channel state between the first communication node and the second communication node is less than a specific criterion while the first communication node performs the relay function, the second communication node may discover other communication node other than the first communication node. In particular, a method that the second communication node discoveries other communication node supporting the relay function may be as follows.

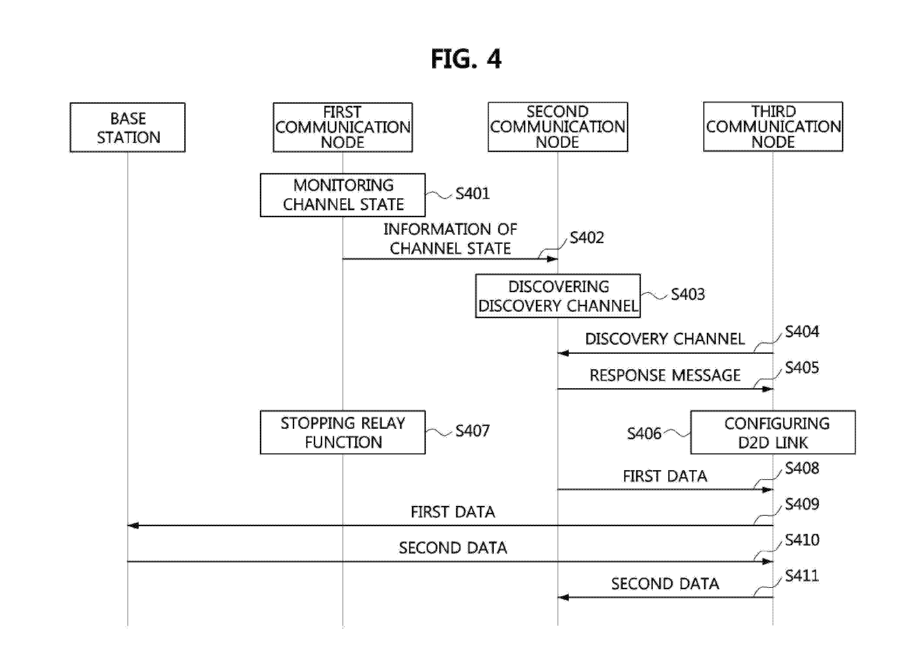

FIG. 4 is a sequence chart showing operation methods of a communication node supporting D2D communications in a communication system according to other embodiment of the present disclosure.

Referring to FIG. 4, the base station, the first communication node, the second communication node, and the third communication node may form the communication system which has been described referring to FIG. 1. For example, the first communication node and the third communication node may be located in the cell coverage (or communication coverage) of the base station. The second communication node may be located in the cell coverage of the base station or out of the cell coverage of the base station. Each of the first communication node, the second communication node, and the third communication node may be identical or similar to the communication node 200 which has been described referring to FIG. 2.

The first communication node may monitor the channel state between the first communication node and the second communication node (S401). Here, the channel state may indicate the data transmission rate or the level of noise included in the channel between the first communication node and the second communication node.

Then, in the case that the channel state between the first communication node and the second communication node is equal to or less than the predefined criterion, the first communication node may transmit information of the corresponding channel state to the second communication node through a D2D channel (S402). For example, the case in that the channel state between the first communication node and the second communication node is equal to or less than the predefined criterion may be occurred when the first communication node is moving away from the base station. In this case, the second communication node may discover other communication node supporting the relay function other than the first communication node.

Alternatively, the second communication node may monitor the channel state between the first communication node and the second communication node and discover a discovery channel when the channel state is equal to or less than the predefined criterion.

In particular, the second communication node may periodically discover the discovery channel which is transmitted from other communication node supporting the relay function other than the first communication node (S403). In FIG. 4, it is described that the steps S401 and S402 are performed prior to the step S403, however, the step S403 may be performed prior to the steps S401 and S402. That is, the second communication node may discover the discovery channel in advance, to prepare that the D2D link configured with the first communication node is unstable.

Meanwhile, the third communication node may be determined to as a communication node supporting the relay function based on the relay operation criterion information of the base station. The third communication node may perform the discovery operation for discovering a counterpart communication node. The radio resources for transmission of the discovery channel may be allocated by the base station or may be configured by the third communication node.

Then, the third communication node may generate a message including information of the radio resources which are allocated by the base station or configured by the third communication node and transmit the generated message in the broadcast manner. In addition, synchronization information of the base station to which the third communication node has accessed may be transmitted through the message including the information of the radio resources or through a fourth communication node (non-shown). The fourth communication node may synchronize with the base station to which the third communication node has accessed.

Therefore, the second communication node may obtain the synchronization information of the base station and synchronize with the base station based on the synchronization information. For example, in the case that the second communication node is located out of the cell coverage of the base station, the second communication node may obtain the synchronization information of the base station from the third communication node or the fourth communication node. Alternatively, in the case that the second communication node is located in the cell coverage of the base station, the second communication node may obtain the synchronization information of the base station from the base station (or third communication node, fourth communication node). The second communication node may receive the message including the information of the radio resources for the transmission of the discovery channel from the third communication node and identify the radio resources through which the discovery channel is transmitted, the transmit power of the discovery channel, and so on based on the message. The second communication node may discover the discovery channel in the identified radio resources.

Then, the second communication node may receive the discovery channel transmitted from the third communication node based on the periodical discovery of the discovery channel (S404). After receiving the discovery channel from the third communication node, the second communication node may perform decoding (e.g., CRC) on the discovery channel. In the case that the decoding on the discovery channel is successfully performed, the second communication node may transmit a response message in response to the discovery channel to the third communication node (S405).

In addition, the second communication node may obtain an indicator which indicates that the third communication node supports the relay function from the discovery channel and identify that the third communication node supports the relay function (e.g., the third communication node relays communications between the base station and the second communication node) based on the indicator. In addition, the second communication node may obtain channel state information between the base station and the third communication node from the discovery channel and identify the channel state between the base station and the third communication node based on the channel state information.

In the case that the plurality of discovery channels are received, the second communication node may select one communication node based on the channel state between each communication node and the base station included in each discovery channel and transmit a response message in response to the discovery channel to the selected communication node.

For example, the second communication node may select the third communication node based on the channel state and generate the response message in response to the discovery channel received from the third communication node. Then, the second communication node may transmit the generated response message to the third communication node.

Meanwhile, the third communication node may receive the response message including a response signal in response to the discovery channel from the second communication node. Then, the third communication node may configure the D2D link with the second communication node (S406). Then, the third communication node may support the communications between the second communication node and the base station by performing the relay function. In this case, the first communication node may stop performing of the relay function. For example, the state of the first communication node may be transitioned from the RRC_CONNECTED state to the RRC_IDLE state and stop the transmission of the discovery channel.

In addition, in the case that first data which will be transmitted to the base station is generated, the second communication node may generate a message including the first data. Then, the second communication node may transmit the message including the first data to the third communication node (S408).

Therefore, the third communication node may receive the message including the first data from the second communication node and transmit the message to the base station (S409). Then, the base station may receive the message including the first data from the third communication node. Then, in response to the message including the first data, the base station may generate a message including second data. Then, the base station may transmit the message including the second data to the third communication node (S410). Then, the third communication node may receive the message including the second data from the base station and transmit the message to the second communication node (S411).

As the foregoing description, the specific method for supporting the communications between the base station and the second communication node in the third communication node may be identical to the method for relaying the communications between the base station and the second communication node in the first communication show in FIG. 3.

In addition, the case in that the second communication node is located out of the cell coverage of the base station has been described in FIG. 4. In contrast, in the case that the second communication node is located in the cell coverage of the base station, the second communication node may measure a radio channel state (e.g., radio link quality) of a PC5 interface between the second communication node and the third communication node by receiving the discovery channel (e.g., by identifying strength of the received discovery channel). The second communication node may transmit information indicating the measured radio channel state to the base station. In addition, the base station may determine a communication node to perform functions based on the radio channel state of the PC5 interface, received from the second communication node, between the second communication node and the third communication node.

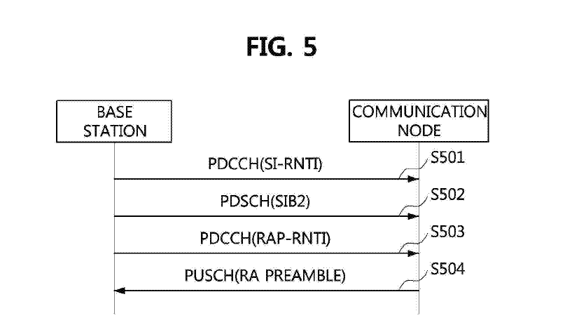

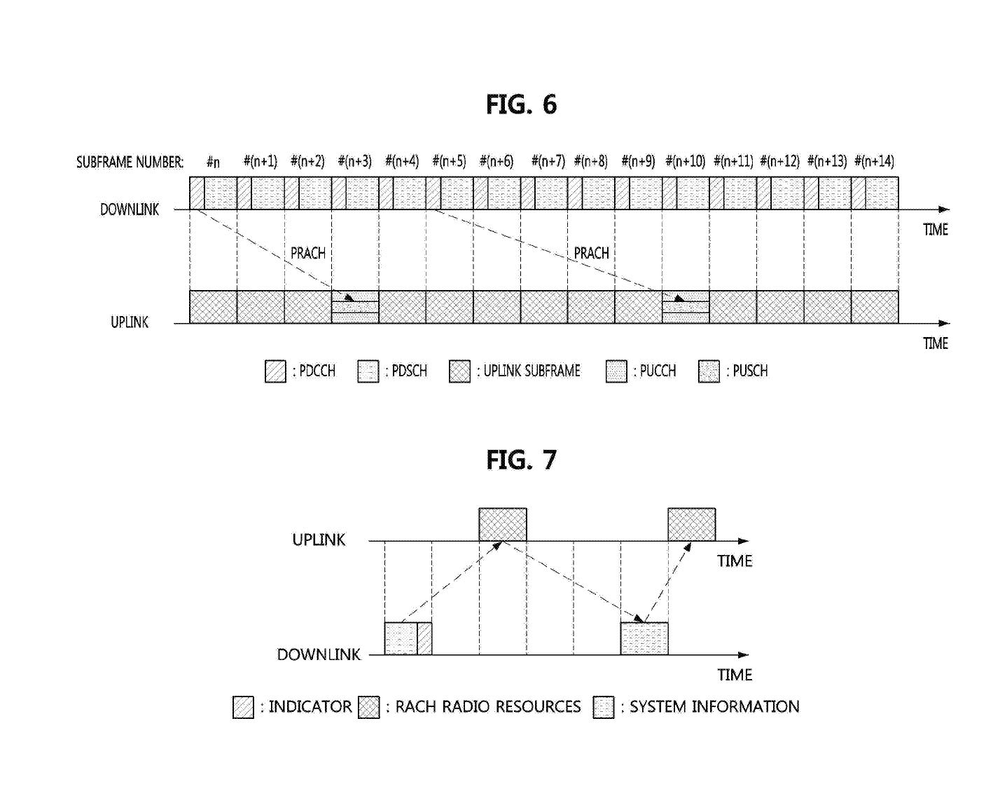

Next, a method for allocating radio resources dynamically through which physical random access channel (e.g. PRACH) used for a random access is transmitted in the communication system according to embodiment of the present disclosure will be described referring to FIGS. 5-6.

In the case that the communication node initially accesses to the base station or scheduling for message transmission is not performed in the communication system, the communication node may access to the base station based on a random access manner. In particular, the communication node may obtain radio resources transmitted through the system information and access to the base station by transmitting PRACH through the obtained radio resources. Here, the base station may transmit information related to fixed radio resources through the system information.

In the communication system according to embodiments of the present disclosure, the base station may allocate dynamically the radio resources for PRACH. Here, the base station may perform resource allocation for PRACH included in a frame through a scheduler of a medium access channel (MAC) layer instead of a RRC layer. Therefore, availability of the radio resources may be enhanced, and a time delay which is occurred while access between the base station and the communication node is performed may be decreased. A detailed method that the base station allocates dynamically the radio resources for PRACH in the communication system may be as follows.

FIG. 5 is a sequence chart showing transmission methods of PRACH in a communication system according to embodiments of the present disclosure.

Referring to FIG. 5, the base station may transmit control channel (e.g. PDCCH) which is scrambled based on UE identifier (e.g. system information-radio network temporary identifier: SI-RNTI) to the communication node (S501). Meanwhile, the communication node may receive the scrambled control channel from the base station and descramble the control channel based on the pre-obtained SI-RNTI.

Then, the base station may configure system information (e.g. SIB2: system information block 2) including information related to the radio resources of PRACH. Here, the information related to the radio resources of PRACH may include at least one of information of random access preamble sequence, transmit signal strength, and information of frequency and time resources. Then, the base station may transmit data channel (e.g. PDSCH) including SIB2 which is scrambled based on SI-RNTI to the communication node (S502).

Therefore, the communication node may receive PDSCH including SIB2 which is scrambled based on SI-RNTI from the base station. Then, the communication node may descramble PDSCH based on SI-RNTI and obtain SIB2 from the descrambled PDSCH. Therefore, the communication node may identify the information related to the radio resources of PRACH included in SIB2. In addition, the communication node may obtain C-RNTI for a specific communication node (e.g., UE-specific RNTI) or group C-RNTI from the base station in advance.

Meanwhile, the base station may configure information related to location of the radio resources of PRACH. Here, the information related to location of the radio resources of PRACH may include at least one of the preamble sequence, the transmit signal strength, and the information of the frequency and time resources. In addition, a downlink control information (e.g. DCI) format including control information of PRACH which is variably transmitted may be identical to a DCI format including control information of PRACH which is statically transmitted. In addition, information of the DCI format including control information of PRACH which is variably transmitted may be transmitted in SIB2 which is transmitted through the step S502.

In addition, the base station may allocate frequency resources among the radio resources of PRACH into center of frequency band as a frequency division duplex (FDD) manner or into an arbitrary region among whole frequency band. Therefore, in the case that many radio resources of PRACH are demanded, the base station may allocate many radio resources of PRACH so that a plurality of communication nodes easily access.

Then, the base station may transmit PDCCH which is scrambled based on the unique UE identifier (C-RNTI or UE-specific RNTI) of the communication node or group identifier (group C-RNTI) to the communication node (S503). That is, the base station may transmit the information related to location of the radio resources of PRACH to the communication node through PDCCH. Here, in the case that the information of the radio resources through which PRACH is transmitted are transmitted to a single communication node, the base station may transmit PDCCH which is scrambled based on the unique C-RNTI of the communication node. In addition, in the case that the information of the radio resources through which PRACH is transmitted are transmitted to a plurality of communication nodes, the base station may transmit PDCCH which is scrambled based on the group C-RNTI.

In addition, the base station may transmit an indicator indicating a size of the radio resources through which PRACH is transmitted to the communication node through PDCCH. For example, the size of the radio resources through which PRACH is transmitted may be configured to be identical to a size of radio resources of general PRACH (e.g., 6 resource blocks (RBs)). In addition, the base station may variably configure the size of the radio resources of PRACH and transmit the indicator indicating the configured size through PDCCH. For example, in the case that the cell coverage of the base station is more than a predefined threshold, the base station may configure the size of the radio resources of PRACH as 2RBs corresponding to relatively small size.

Therefore, the communication node may receive PDCCH which is scrambled based on C-RNTI or group C-RNTI from the base station. Then, the communication node may descramble scrambled PDCCH based on pre-obtained C-RNTI or group C-RNTI and obtain the information of the radio resources through which PRACH is transmitted included in PDCCH.

Then, the communication node may generate the random access preamble. Here, the random access preamble may include a cyclic prefix (CP) and the preamble sequence. In addition, a preamble sequence number may be specified in the base station in advance and the pre-specified preamble sequence may be transmitted to the communication node through at least one of steps S501 to S503 in advance. Therefore, the communication node may obtain the preamble sequence included in the random access preamble.

Alternatively, in the case that the preamble sequence is not obtained from the base station in advance, the preamble sequence may be configured by the communication node. That is, the communication node may basically select an arbitrary value among 62 preamble sequences as the preamble sequence to be included in the random access preamble. However, in the case that the communication node wants to indicate specific meaning using the random access preamble, the communication node may select a preamble sequence having a value (e.g., 1 or 2) which is configured to indicate the specific meaning. For example, in the case that the communication node requests radio resources for transmission of uplink data, the preamble sequence may be configured to as 1. Alternatively, in the case that the communication node requests radio resources for transmission of direct communications, the preamble sequence may be configured to as 2.

Then, the communication node may generate uplink data channel (e.g. PUSCH) including the random access preamble and transmit the generated PUSCH to the base station through PRACH (S504). Here, the communication node may transmit the random access preamble to the base station at a transmission time of PRACH configured by the base station. Next, a detailed method for transmitting the random access preamble in the transmission time of PRACH configured by the base station will be described referring to FIG. 6.

FIG. 6 is a conceptual diagram showing allocation methods of radio resources for PRACH in a communication system according to embodiments of the present disclosure.

Referring to FIG. 6, a transmission state of a message through an uplink and a downlink between the base station and the communication node included in the communication system may be indicated. The information of the radio resources of PRACH transmitted from the base station may include or not include the information of the time resources of PRACH. That is, the communication node may receive or not receive the information of the time resources of PRACH from the base station.

First, in the case that the information of the time resources of PRACH is not received, the communication node may basically transmit at a predefined fixed time (e.g., a time after receiving 3 subframes from a reception time of a subframe#n) to the base station. For example, the base station may transmit the subframe#n including PDCCH and PDSCH to the communication node. Therefore, the communication node may receive the subframe#n from the base station. Then, the communication node may identify that PDCCH of the subframe#n does not include the information of the time resources of PRACH. Then, the communication node may transmit PRACH to the base station at a time of a subframe#(n+3) as the time after receiving 3 subframes from the reception time of a subframe#n.

In addition, a case in that the information of the radio resources of PRACH includes the information of the time resources of PRACH may be as follows. The base station may transmit a subframe#(n+5) including PDCCH and PDSCH to the communication node. Therefore, the communication node may receive the subframe#(n+5) from the base station. Then, the communication node may identify that the information of the time resources of PRACH is included in the subframe#(n+5). Here, the information of the time resources may be information indicating to transmit after 2 subframes. Then, the communication node may transmit PRACH to the base station at a time of a subframe#(n+10) as a time after additional 2 subframes from a reception time of 3 subframes (i.e., fixed transmission time) after the reception time of the subframe#(n+5). Alternatively, in consideration of the information of the time resources of PRACH without the fixed transmission time, the communication node may transmit PRACH to the base station at a time of a subframe#(n+7) after 2 subframes from the reception time of the subframe#(n+5). Then, the base station may receive the random access preamble from the communication node through PRACH.

Next, a method for decreasing complexity of the random access in the communication system according to embodiments of the present disclosure will be described.

Generally, the random access between the base station and the communication node may be performed based on fixed radio resources allocated by the base station in the communication system. In particular, the base station may transmit the fixed radio resources through which PRACH is transmitted through system information channel in the broadcast manner, and the communication node may transmit PRACH based on the corresponding radio resources. Therefore, the base station may receive PRACH from the communication node and determine whether PRACH is transmitted from the communication node.

In the case that the plurality of communication nodes transmit PRACH to the base station based on the fixed radio resources, each communication node may select an arbitrary preamble sequence among the plurality of preamble sequences and transmit the selected preamble sequence in PRACH. Therefore, in the case that PRACH is received from the plurality of communication nodes based on the fixed radio resources, the base station may identify each communication node based on the preamble sequence included in each PRACH and transmit a response message in response to PRACH of each identified communication node.

In the communication system according to embodiments of the present disclosure, the base station and the communication node may perform the random access procedure through a fixed preamble sequence. In particular, the base station may use predefined fixed radio resources for the random access of the communication node. Here, the predefined fixed radio resources may indicate radio resources used in a communication node which does not obtain the synchronization information of the uplink among the plurality of communication nodes existed in the communication system. In addition, the base station may transmit a response message in response to PRACH based on radio resources of the corresponding communication node for PRACH received from the communication node.

That is, the base station may allocate different radio resources through which PRACH is transmitted to each of the plurality of communication nodes. In other words, the base station may allocate different location information of PRACH to respective communication nodes. Therefore, the base station may identify the communication node by identifying the radio resources through which PRACH is transmitted without identification of the random access preamble sequence of PRACH received from the communication node.

Here, the fixed radio resources of PRACH which are used between the base station and the communication node may be changed according to a predefined period. That is, the base station may change the fixed radio resources of PRACH which are used between the base station and the communication node according to the predefined period and transmit the changed fixed radio resources of PRACH to the communication node. In addition, the base station may configure the fixed radio resources of PRACH to be located in a center region of whole frequency band, therefore, the communication node may receive although a range of whole frequency band is narrow. Next, detailed descriptions related to that will be described in detail referring to FIG. 7.

FIG. 7 is a conceptual diagram showing a random access procedure in a communication system according to embodiments of the present disclosure.

Referring to FIG. 7, the transmission state of the message through the uplink and the downlink between the base station and the communication node in the communication system may be indicated. The base station may transmit a message including the system information to the communication node existed in the cell coverage of the base station. Here, the message including the system information may be transmitted in the broadcast manner. In addition, the system information may include a cell identifier (e.g., cell ID, public land mobile network (PLMN) ID, tracking area ID), downlink physical channel information (e.g., bandwidth), cell limitation information (e.g., cell barring), paging channel information, and so on. In addition, the system information may further include a beam identifier (ID), a system information indicator, uplink physical channel information, and so on. In addition, the system information may further include an indicator indicating that some of system information change.

Then, the communication node may receive the message including the system information from the base station. Then, the communication node may obtain the system information included in the message. In addition, the base station may obtain the information of the radio resources included in the system information and identify existence of the changed system information through the indicator indicating that some of system information change. Then, the communication node may generate a message requesting the changed system information based on the radio resources and transmit the generated message to the base station through the random access channel. That is, the communication node may transmit the random access preamble for requesting the changed system information to the base station.

Therefore, the base station may receive the random access preamble for requesting the changed system information from the communication node. Then, the base station may configure the changed system information. Here, the changed system information may include information of cell selection or cell reselection. In addition, the changed system information may further include control information used for transitioning the state of the communication node to as the RRC_CONNECTED state. Then, the base station may generate a message including the changed system information and transmit the generated message to the communication node. That is, the base station may perform a response of the random access preamble received from the communication node.

Here, the base station may allocate different radio resources of PRACH to the plurality of communication nodes existed in the communication system. Therefore, each communication node may transmit the random access preamble based on the radio resources of the PRACH which are allocated to it. Therefore, in the case that the random access preambles are received from the plurality of communication nodes, the base station may identify each communication node by identifying the radio resources through which the random access preamble is received, without identification of the random access preamble sequence received from each communication node.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first communication node supporting device to device (D2D) communications in a communication system, the operation method comprising:
receiving relay operation criterion information from a base station;
when it is determined that the first communication node supports a relay function based on the relay operation criterion information, transmitting a first message indicating that the first communication node supports the relay function to the base station; and
when a second message which instructs performing of the relay function is received from the base station in response to the first message, relaying communications between the base station and a second communication node by performing the relay function.

2. The operation method of claim 1, wherein, when the first communication node is in a radio resource control (RRC) connected state, the relay operation criterion information are received through a RRC message.

3. The operation method of claim 1, wherein, when the first communication node is in a RRC idle state, the relay operation criterion information are received through a reception procedure of system information or a paging procedure.

4. The operation method of claim 1, wherein the relay operation criterion information include at least one of a threshold for a noise level of a channel, a threshold for a data transmission rate, and a threshold for a battery remaining capacity.

5. The operation method of claim 1, further comprising transmitting state information of the first communication node to the base station,
wherein the state information are used for determining an arbitrary communication node to perform the relay function and include a noise level of a channel in which the first communication node operates, a data transmission rate supported by the first communication node, and a battery remaining capacity of the first communication node.

6. The operation method of claim 4, further comprising performing state transition of the first communication node from a RRC connected state to a RRC idle when the second message is not received in predefined time duration.

7. The operation method of claim 1, wherein the relaying the communications between the base station and the second communication node comprising:
transmitting a discovery channel;
receiving a response signal in response to the discovery channel from the second communication node; and
configuring a D2D link between the first communication node and the second communication node.

8. The operation method of claim 7, wherein information of radio resources in which the discovery channel is transmitted are obtained from the base station or configured by the first communication node.

9. The operation method of claim 6, wherein the information of the radio resources include information of time and frequency resources of the discovery channel, information of transmit power, period information, and synchronization information.

10. The operation method of claim 1, wherein the first communication node is located in cell coverage of the base station, and the second communication node is located out of the cell coverage of the base station.

11. A first communication node supporting device to device (D2D) communications in a communication system, comprising:
a processor; and
a memory storing at least one command which is executed by the processor,
wherein the at least one command is executed to receive relay operation criterion information from a base station;
when it is determined that the first communication node supports a relay function based on the relay operation criterion information, transmit a first message indicating that the first communication node supports the relay function to the base station; and
when a second message which instructs performing of the relay function is received from the base station in response to the first message, relay communications between the base station and a second communication node by performing the relay function.

12. The first communication node of claim 11, wherein, when the first communication node is in a radio resource control (RRC) connected state, the relay operation criterion information are received through a RRC message.

13. The first communication node of claim 11, wherein, when the first communication node is in a RRC idle state, the relay operation criterion information are received through a reception procedure of system information or a paging procedure.

14. The first communication node of claim 11, wherein the relay operation criterion information include at least one of a threshold for a noise level of a channel, a threshold for a data transmission rate, and a threshold for a battery remaining capacity.

15. The first communication node of claim 11, wherein the at least one command is further executed to transmit state information of the first communication node to the base station,
wherein the state information are used for determining an arbitrary communication node to perform the relay function and include a noise level of a channel in which the first communication node operates, a data transmission rate supported by the first communication node, and a battery remaining capacity of the first communication node.

16. The first communication node of claim 14, wherein the at least one command is further executed to perform state transition of the first communication node from a RRC connected state to a RRC idle when the second message is not received in predefined time duration.

17. The first communication node of claim 11, wherein, when the communications between the base station and the second communication node are relayed, the at least one command is executed to transmit a discovery channel;
receive a response signal in response to the discovery channel from the second communication node; and
configure a D2D link between the first communication node and the second communication node.

18. The first communication node of claim 17, wherein information of radio resources in which the discovery channel is transmitted are obtained from the base station or configured by the first communication node.

19. The first communication node of claim 16, wherein the information of the radio resources include information of time and frequency resources of the discovery channel, information of transmit power, period information, and synchronization information.

20. The first communication node of claim 11, wherein the first communication node is located in cell coverage of the base station, and the second communication node is located out of the cell coverage of the base station.
